(19) United States
(12) Patent Application Publication
(10) Pub. No.: US 2026/0363477 A1
(43) Pub. Date: Nov. 19, 2026

(54) METHOD AND SYSTEM FOR CONTAINMENT OF AND CHANGING THE TEMPERATURE OF THERMALLY CONTROLLED FLUIDS

(71) Applicant: Michael Henry, Michie, TN (US)

(72) Inventor: Michael Henry, Michie, TN (US)

(21) Appl. No.: 19/544,960

(22) Filed: Feb. 19, 2026

Related U.S. Application Data
(60) Provisional application No. 63/760,183, filed on Feb. 19, 2025.

(51) Int. Cl. A47J 27/00; A47J 37/12

(52) U.S. Cl. CPC A47J 27/002; A47J 27/004; A47J 37/1209; A47J 37/129

(57) ABSTRACT

A dual purpose fryer, boiler, and cooler which utilizes a common pot for containing fluid whether hot or cold, the pot has a hole in it for receiving an electric heating element, the hole is near the bottom of the pot but not at the bottom to provide space for matter in the oil or water to settle and stay off the food.

### CROSS REFERENCE TO RELATED APPLICATIONS

This application is a nonprovisional application which claims the benefit of the filing date of provisional patent application entitled BUCKET APPLICATION having Ser. No. 63/760,183 filed on Feb. 19, 2025, by Michael Henry, which application is incorporated herein in its entirety by this reference.

### FIELD OF THE INVENTION

The present invention generally relates to containers for containing fluids and other objects, and more particularly relates to methods and systems utilizing a dual-purpose common container for heating fluids therein and for insulating fluids therein from external heat sources.

### BACKGROUND OF THE INVENTION

In the past, turkey fryers have been used to cook whole turkeys in oil. These fryers have been extremely popular. However, they have some drawbacks. Many of these fryers use propane tanks as a source of fuel to heat the oil. This requires proper storage of the tanks, refilling the tanks, or returning them for a full tank for continued operation. Electric fryers have been used in the past but have one or more shortcomings, such as being too small for a whole turkey, those that are not too small often are either too slow to heat the oil or they require storage space which is too larger for their limited occasions of use.

Consequently, there exists a need for improved methods and systems for efficiently and easily frying a whole turkey, without use of propane and without taking up too much storage space for the typical infrequent use such a large device.

### SUMMARY OF THE INVENTION

It is an object of the present invention to provide the capability of electric frying a whole turkey in an efficient and cost and space effective manner.

It is a feature of the present invention to utilize a relatively low-cost system, with high performance and quick heating.

It is another feature of the present invention to turn off a booster fan with the aid of information relating to a magnitude of a deviation of a sensed air duct temperature to a maximum or minimum sensed air duct temperature.

It is yet another feature of the present invention to conserve storage space by providing dual purpose to the liquid container as both a hot oil container and a cooler for containing ice, beverages food, etc.

It is an advantage of the present invention to avoid inefficiencies resulting from having a large dedicated fryer and a dedicated beverage cooler.

The present invention is carried out wasted space less manner, in a sense that the occasions of use of this device are not limited to just frying.

Accordingly, the present invention is a method of assembling a turkey fryer and converting the same into a rugged cooler, comprising the steps of:
providing a pot size and configured to allow a turkey to be lowered therein from a top portion of the pot;
providing a heating element 26 for converting electricity to heat; making a hole at a predetermined distance above a bottom portion of the pot 10;
said hole is sized and configured to permit reception therethrough of a hub 36 having an interior portion 35 and exterior portion 37; and an orifice extending therethrough;
said hub being provided with a threaded member on an internal surface of said orifice through said exterior portion 37 and exterior threading on said interior portion 35;
said hub 36 and said heating element 26 being configured so that turning of the heating element within the hub can cause a leak proof seal to exist therebetween;
said interior portion of said hub configured to mate with a threaded member 32 with an O ring 34 disposed therebetween;
said hub 36 and said threaded member configured to cause a leak proof seal when said O ring 34 is compressed therebetween;
proving a tray 14 disposed at a bottom portion of the pot 10 and also disposed above said heating element 26; and
inserting said heating element 28 through said hole.

Additionally, the present invention is an improved system for frying comprising:
A system for changing a temperature characteristic of a fluid, the system comprising: a pot 10, with a hole through a side of said pot 10, a hub 36 disposed through the hole and extending into an interior portion of the pot 10, a heating structure extending through the hub, and into the pot 10, the pot 10 being covered by a neoprene cover.

### BRIEF DESCRIPTION OF THE DRAWINGS

The invention may be more fully understood by reading the following description of the preferred embodiments of the invention, in conjunction with the appended drawings wherein:

FIG. 1 is exploded view of the dual-purpose fryer and cooler system of the present invention.

FIG. 2 is a close-up view of a portion of the invention where heat is being applied before shrinking of coverings.

FIG. 3 is another close-up view of a portion of the invention where heat is being applied after shrinking of the inner covering.

FIG. 4 is yet another view of heat being applied to the outer covering.

FIG. 5 is a close-up view of an earlier action of attaching the wires from the power line to the terminal portion of the heating element.

FIG. 6 is a fully assembled view of the heating element with the 500 degree O ring disposed thereon.

FIG. 7 is a view of a drill about to make a hole for reception of the heating element.

FIG. 8 is a view of the pot 10 after having the hole drilled and the hub has been installed.

FIG. 9 is an inside view of the pot 10 with a distal portion of hub 36 extending into the pot 10 before any lock washer 32 is installed.

FIG. 10 is a view of the process of the hub 36 being turned by a channel lock grasping port 37 of hub 36.

FIG. 11 is a view of the heating element 26 being inserted into the pot 10 through the hub 36.

FIG. 12 is an internal view of the heating element inside the pot 10.

FIG. 13 is a fully assembled view of the present invention, except for the insulating cover being disposed on the outside of pot 10.

FIG. 14 is view of an embodiment of the present invention with navy grade rope for a handle that facilitates carrying and includes a pot cover 200 which could be neoprene or other suitable material to insulate the cool contents of the pot when it is being used as a cooler and to insulate the surface of upon which it rests during operation for heating at certain temperatures.

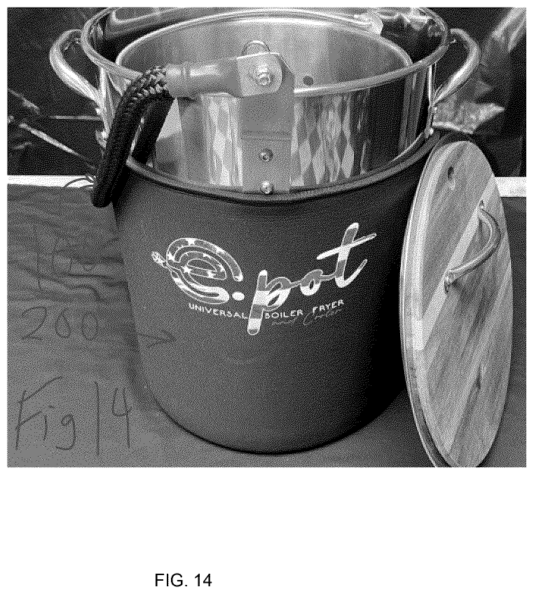

### DETAILED DESCRIPTION

Although described with particular reference to turkey fryers, the systems and methods of the present invention can be implemented to heat water, oil and other fluids.

In an embodiment, the system and method of the present invention described herein can be viewed as examples of many potential variations of the present invention which are protected hereunder. The following details are intended to aid in the understanding of the invention whose scope is defined in the claims appended hereto.

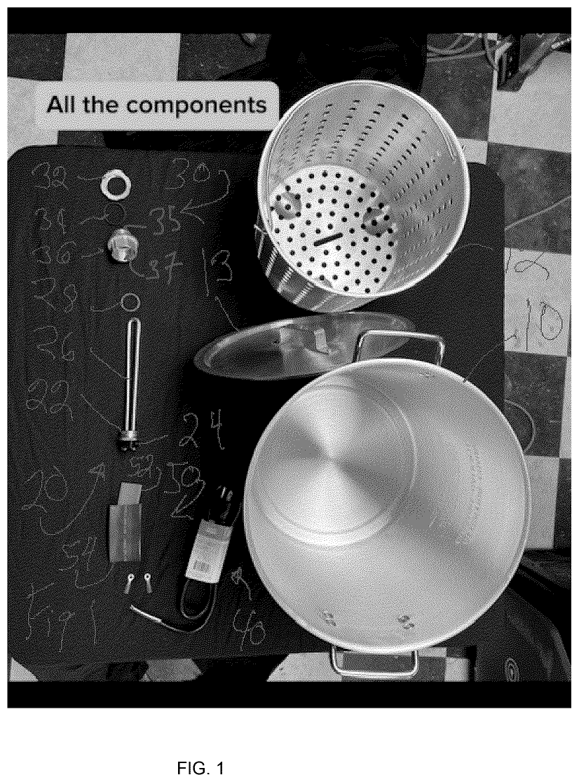

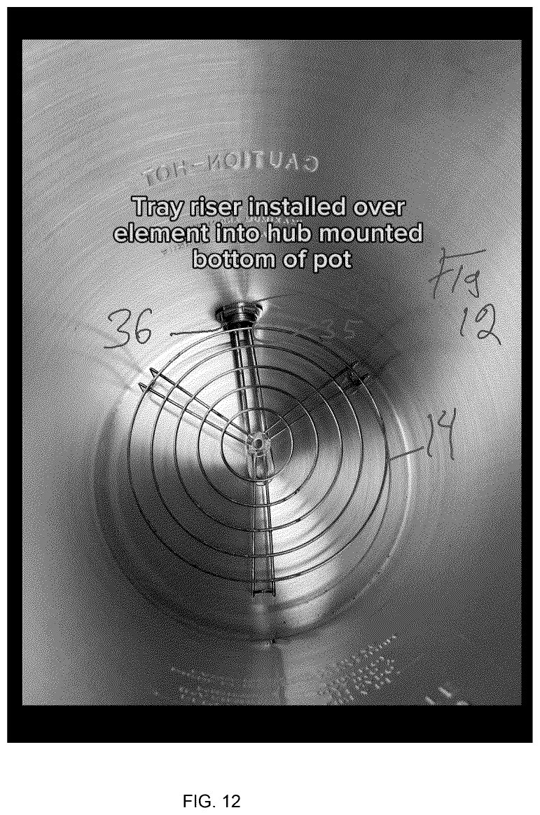

Now referring to the drawings wherein like numerals refer to like matter throughout, and more particularly in FIG. 1, there is shown a dual-purpose pot 10 in proximity with other components of the present invention other than the insulated cover over the pot and the tray 14 shown in FIG. 12.

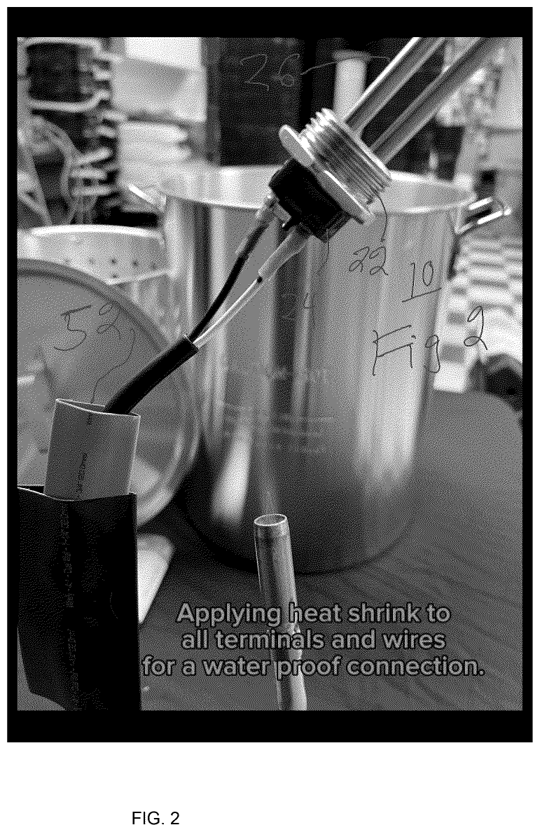

Now referring to FIG. 2, there is shown a heating element 26 and a terminal block 24 and a threaded hub mating portion 22. Shrink covering 52 is shown in a configuration before being exposed to heat.

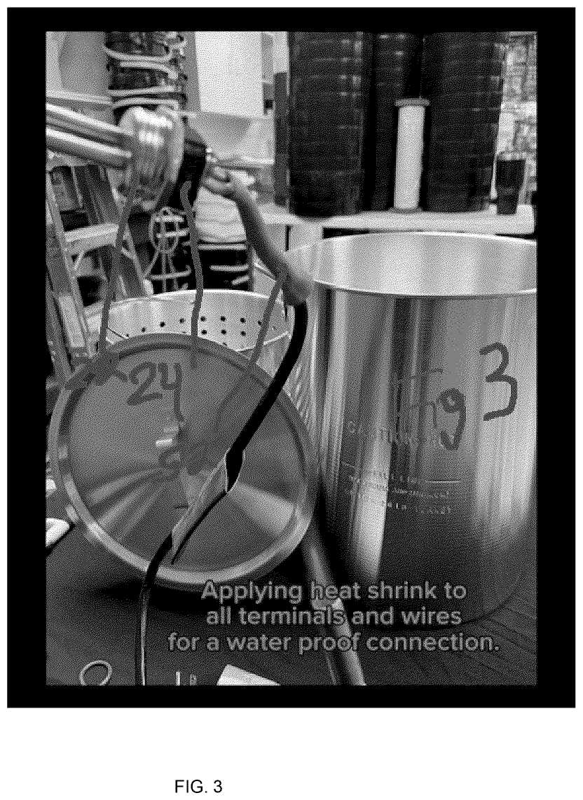

Now referring to FIG. 3, there is shown internal shrink covering 52 after having been exposed to heat.

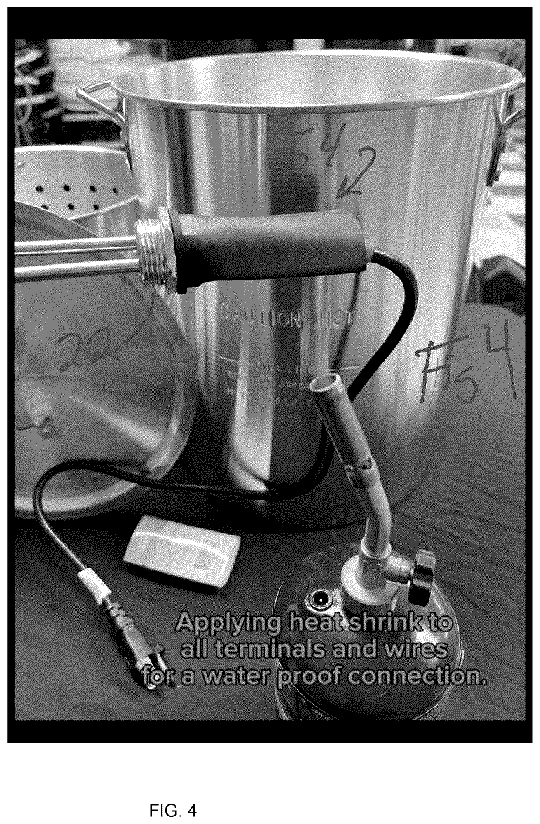

Now referring to FIG. 4, there is shown a view of external shrink covering 54 after having been exposed to heat.

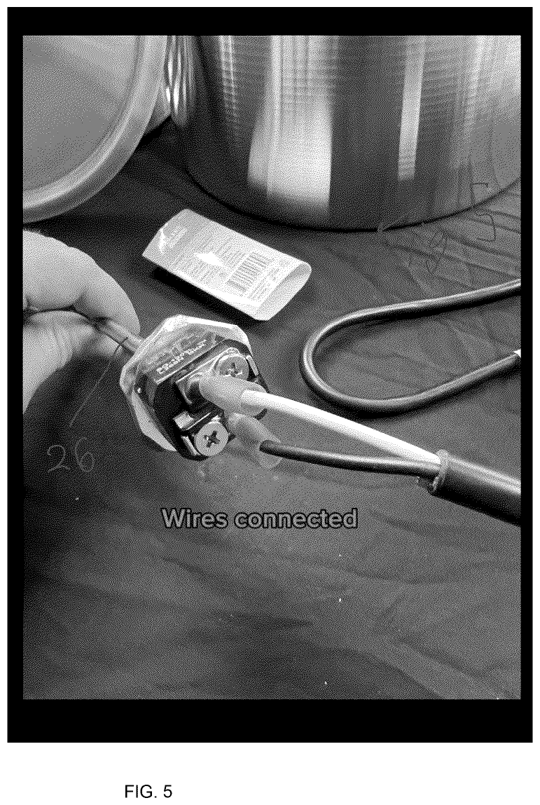

Now referring to FIG. 5, there is shown a view of terminal block 24 with wires for providing power to heating element 26 attached.

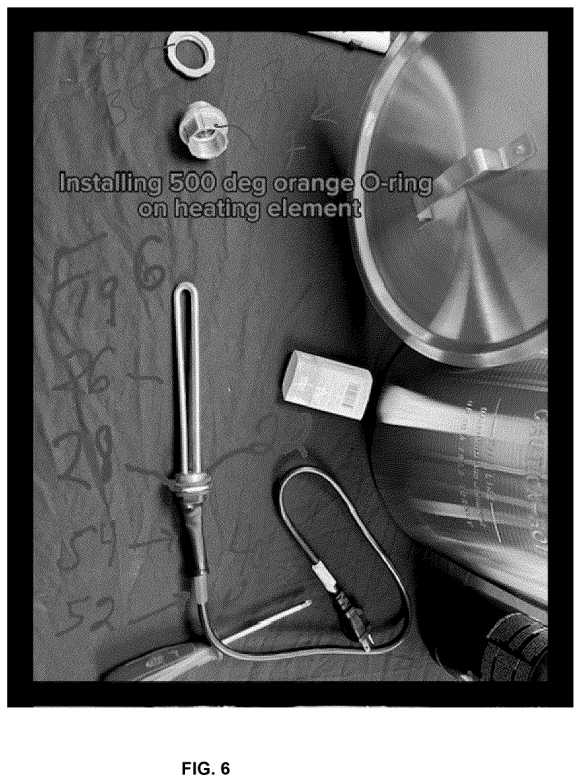

Now referring to FIG. 6, there is shown an exploded view of the assembled heating element with the hub 36 and the threaded member 32. Not shown is the O ring 34 of FIG. 1 which, when assembled, is disposed about the interior threaded portion 35 and between central portion of hub 36.

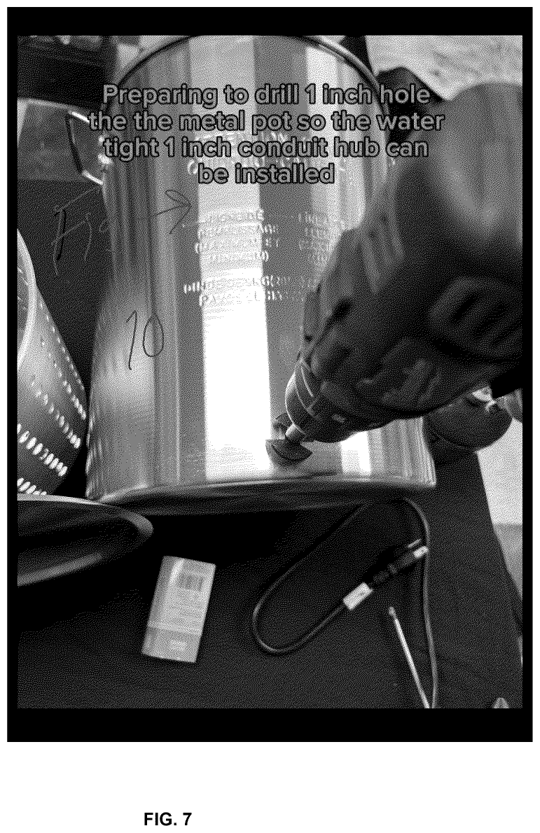

Now referring to FIG. 7, there is shown a portion of the method of making the present invention by drilling a hole through a lower portion of the pot 10.

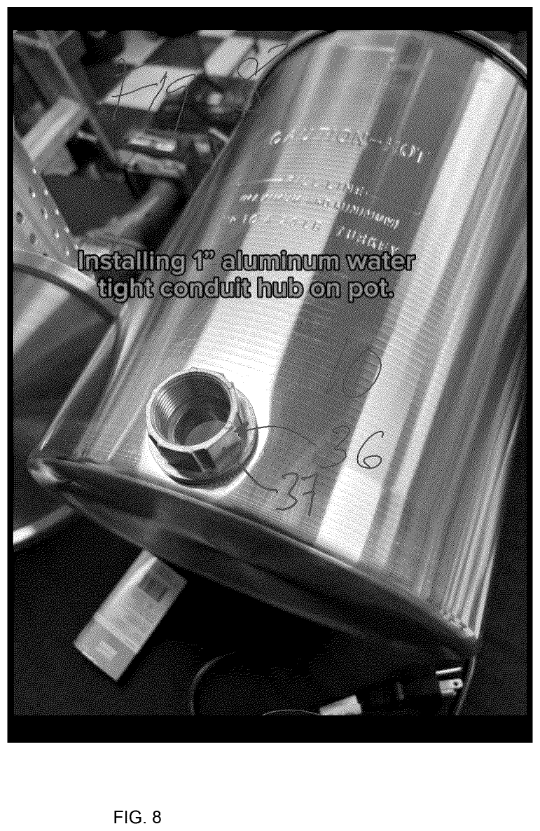

Now referring to FIG. 8, there is shown a stage of assembly of the present invention where the hub 36 is partially disposed through the hole.

Exterior portion 37 denotes the outside portion of hub 36 which has an outside surface configured to mate with wrenches.

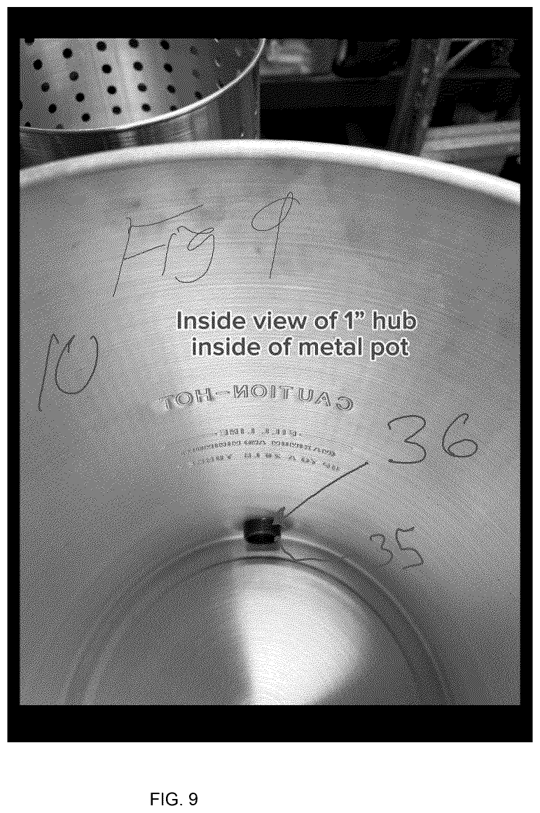

Now referring to FIG. 9, there is shown the interior portion 35 of the hub 36 which is extending through the hole. Not shown in this figure is the threaded member 32 which helps hold the hub in a sealed configuration with the pot 10 when the threads of portion 35 are caused to advance sufficiently with respect to the threads of threaded member 32.

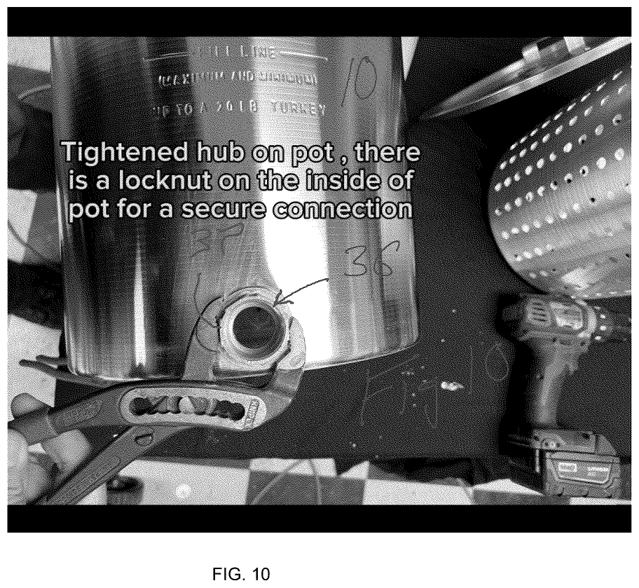

Now referring to FIG. 10, there is shown a channel lock tool being used to turn portion 35 of the hub to mate further with portions of the threaded member 32.

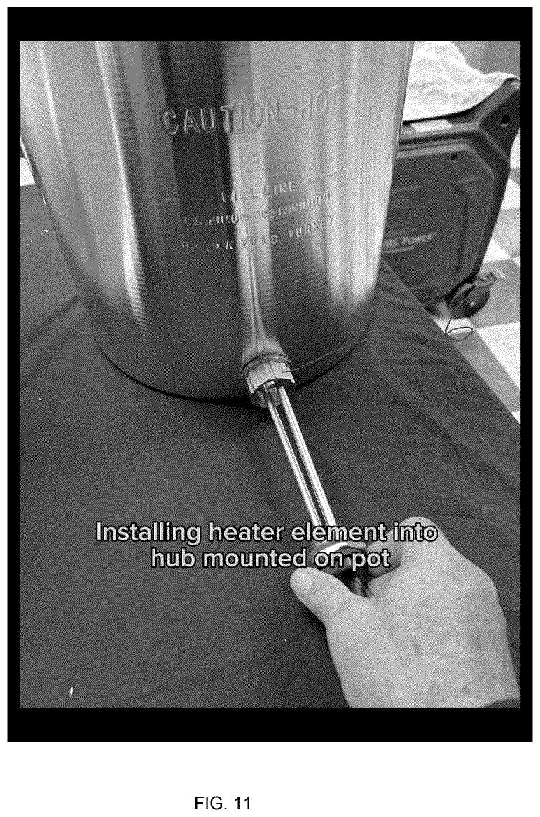

Now referring to FIG. 11, there is shown the heating element being inserted through the hub 36 and thereby inside of the pot 10.

Now referring to FIG. 12, there is shown an interior view of the pot 10 where the interior portion 35 of hub 36 is shown extending to the pot 10 and the threaded member is shown disposed about portion 35 and adjacent to an interior side of the pot 10. Disposed at the bottom of the pot 10 and separated therefrom by a predetermined distance, which could be in some embodiments about an inch. The tray 24 supports a turkey disposed in the pot 10 but does not allow the turkey to sit on the bottom of the pot 10 or touch the heating element.

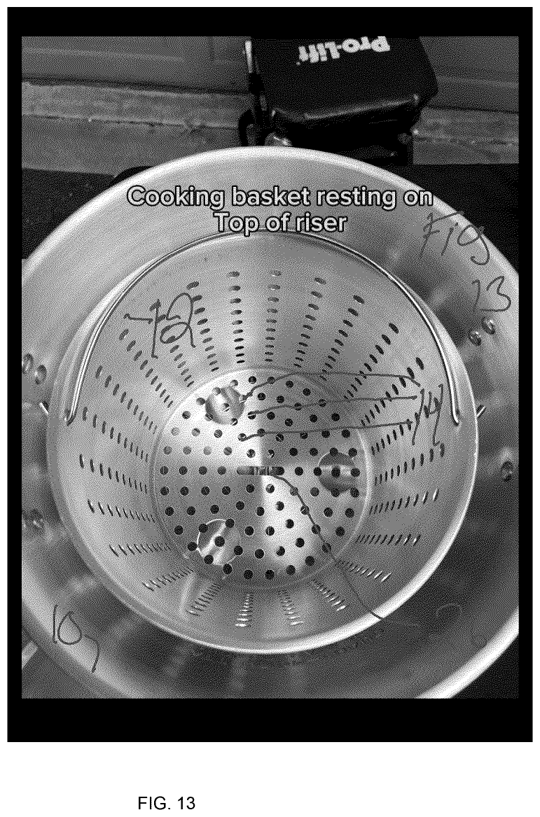

Now referring to FIG. 13, there is a view of the present invention with a cooking basket 12 being disposed above the tray 14, portion of which can be seen through holes in the bottom portion of cooking basket 12. The heating element is seen through a central slot at the bottom of basket 12.

The present invention may be optimized for frying whole turkeys if the heating element 26 is a heating element which could be used to heat water in a 30 gallon residential electric water heater, moreover a 2000 watt 110 volt heating element might be sized well for a pot 10 that is 30 quarts in size, the hub 36 could be of the type used in residential water heaters to facilitate placement and replacement of heating element in residential water heaters.

It is thought that the method of making the apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred and/or exemplary embodiment thereof.

1. A method of making a turkey fryer comprising the steps of:
providing a pot size and configured to allow a turkey to be lowered therein from a top portion of the pot;
providing a heating element 26 for converting electricity to heat;
making a hole at a predetermined distance above a bottom portion of the pot 10;
said hole is sized and configured to permit reception therethrough of a hub 36 having an interior portion 35 and exterior portion 37; and an orifice extending therethrough;
said hub being provided with a threaded member on an internal surface of said orifice through said exterior portion 37 and exterior threading on said interior portion 35;
said hub 36 and said heating element 26 being configured so that turning of the heating element within the hub can cause a leak proof seal to exist therebetween;
said interior portion of said hub configured to mate with a threaded member 32 with an O ring 34 disposed therebetween;
said hub 36 and said threaded member configured to cause a leak proof seal when said O ring 34 is compressed therebetween;
proving a tray 14 disposed at a bottom portion of the pot 10 and also disposed above said heating element 26; and
inserting said heating element 28 through said hole.

2. The method of claim 1 wherein said heating element is a 2000 watt element.

3. The method of claim 1 wherein said tray 14 is disposed a predetermined distance about the bottom portion of pot 10, so that when matter transported with said turkey into said pot 10 becomes free from said turkey a volume below said tray 14 allows said matter to settle and remain displaced from the turkey when it is cooked and removed.

4. A system for changing a temperature characteristic of a fluid, the system comprising: a pot 10, with a hole through a side of said pot 10, a hub 36 disposed through the hole and extending into an interior portion of the pot 10, a heating structure 26 extending through the hub, and into the pot 10.

5. The system of claim 4 wherein said pot is covered by a neoprene cover having a predetermined thickness characteristic which is determined depending upon the surface upon which it sits and the temperature of the fluid.

6. The system of claim 4 wherein the hub 36 is configured to have a watertight seal with respect to the pot 10.

7. The system of claim 6 wherein said watertight seal is formed by rotating, with respect to the threaded member, threads on an interior portion of the hub thereby causing the combination of the hub 36 and the threaded member 32 to tighten to the pot 10.

8. The system of claim 7 wherein a first O ring is disposed between said threaded member and a portion of said hub.

9. The system of claim 8 wherein a second O ring is disposed between a portion of said heating structure and a portion of said hub.

10. The system of claim 9 wherein said heating structure is a heating element configured to be installed into a residential electric water heater.

11. The system of claim 10 wherein said heating element is a 2000-watt 110-volt electric heating element.

12. The system of claim 11 wherein said heating element is located below a tray 14 which performs a function of protecting said heating element and provides a space below said tray 14 where foreign matter has space to settle displaced from an object being heated in said pot.

13. The system of claim 9 wherein said fluid is oil and said object is a turkey.

14. The system of claim 13 wherein said pot is covered by a neoprene cover.

15. A dual-purpose container system comprising:
a pot having a bottom portion, side walls, and a top opening;
a hub disposed through a hole in said side walls at a predetermined distance above said bottom portion, said hub having internal threading;
a heating element insertable through said hub and extending into an interior of said pot;
a threaded member configured to engage with said hub and secure said heating element in a leak-proof manner;
a tray disposed within said pot above said heating element; and
a removable insulating cover disposed about an exterior of said pot.

16. The system of claim 15, wherein said heating element is removable to permit use of said pot as a cooler.

17. The system of claim 16 wherein a portion of said heating element has a 500-degree O ring disposed thereon.

18. The system of claim 16, wherein said insulating cover comprises neoprene material.

19. The system of claim 17 wherein said threaded member is a lock washer.

20. A method of making a turkey fryer out of a cooler, comprising the steps of:
providing a pot with an insulating cover;
wherein a combination of said pot and said insulating cover, in combination, are configured to perform as a cooler;
removing said insulating cover; and
inserting a portion of a 2000-watt 110-V electric heating element through a one-inch aluminum watertight conduit hub, into the pot.
